(19) United States
(12) Patent Application Publication
(10) Pub. No.: US 2007/0019030 A1
(43) Pub. Date: Jan. 25, 2007

(54) Wiping apparatus and method for print head in inkjet printer

(75) Inventor: You-sim Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/367,400

(22) Filed: Mar. 6, 2006

(30) Foreign Application Priority Data
Jul. 22, 2005 (KR) 2005-0066878

(51) Int. Cl. B41J 2/165

(52) U.S. Cl. 347/33

(57) ABSTRACT

A wiping apparatus for a print head in an inkjet printer includes a blade support; and a wiping blade disposed on an upper surface of the blade support. A contact point of the wiping blade with the print head is not on the same line.

### CROSS-REFERENCE TO RELATED APPLICATIONS

This application claims the benefit under 35 U.S.C. § 119 from Korean Patent Application No. 2005-66878 filed on Jul. 22, 2005 in the Korean Intellectual Property Office, the entire contents of which are hereby incorporated by reference.

### BACKGROUND OF THE INVENTION

1. Field of the Invention

The present invention relates to an inkjet printer. More particularly, the present invention relates to a wiping apparatus and a wiping method for a print head in an inkjet printer.

2. Description of the Related Art

An inkjet printer uses a cartridge spraying ink droplets onto a recording medium. The cartridge includes a print head having very small nozzles, and the ink droplets are ejected through the nozzles. To print an image, the print head moves forward and backward across the recording medium, and the ink droplets are sprayed in a desired pattern as the print head moves. A specific inkjet system in the print head may have a different shape according to the piezoelectric or thermal print head techniques well known to those skilled in the art. For example, two initial thermal inkjet systems are disclosed in U.S. Pat. Nos. 5,278,584 and 4,684,481. In the thermal systems, a barrier layer having ink channels and vaporization chambers is placed between a nozzle orifice plate and a substrate layer. The substrate layer usually contains linear arrays of heater elements, such as a register, and power is applied such that the heater elements heat the ink in the vaporization chamber. When the ink is heated, the ink droplets are sprayed from the nozzle associated with the register. As the print head moves across a paper, the power is selectively applied to the register and the ink is sprayed in a pattern onto the recording medium and forms a predetermined image.

Typically, a “service station” system to wipe and protect the print head is supported by a printer chassis such that the print head can move on the station to be maintained and repaired. During the keeping or non-printing period, the service station usually includes a capping system, by which the print head nozzles are actually tightly closed to protect against impurities and drying. Some caps are designed to enhance the priming by being connected with a pump for pumping out a vacuum on the print head. During operation, the clogs in the print head are periodically cleaned as a number of ink droplets are ejected through each nozzle by the process publicly known as the “spitting” process, and the waste ink is collected in a separate reservoir portion provided in the service station. After spitting or uncapping or sometimes during printing, most service stations have elastic polymer wipers, and these elastic polymer wipers wipe the print head surface to remove ink residues, paper dust and other small fragments that collect on the print head. Generally, the wiping operation is performed by the relative motion of the print head and the wiper, for example, by moving the print head across the wiper, moving the wiper across the print head, or moving both print head and wiper.

FIG. 1 shows a structure of a conventional wiping apparatus for a print head in an inkjet printer.

With reference to FIG. 1, a print head 3 is shown in which a number of nozzles (not shown) are provided on a lower surface of a cartridge 1 to spray ink droplets. Reference number 7 denotes a wiping apparatus engaging a bottom surface of the print head to wipe the bottom surface of the print head 3. The wiping apparatus 7 includes an ink absorption body 7a, which is disposed at a predetermined distance from the bottom surface of the print head 3 and performs a straight back and forth movement, and a wiping blade 7b, which is disposed in an upper surface of the ink absorption body 7a and engages the bottom surface of the print head 3.

FIGS. 2A through 2D show states that the wiping blade of the conventional wiping apparatus of FIG. 1 engages the print head according to a wiping movement direction. FIG. 3 is a graph showing that a motor is loaded when the wiping blade of the conventional wiping apparatus is in contact with the print head.

In the conventional wiping apparatus as described above, the wiping blade 7b is disposed at a right angle to the wiping movement direction A (FIG. 1), and a sudden frictional load is momentarily generated at the beginning (that is, the state shown in FIG. 2B) when the wiping blade 7b is in contact with the print head 3. Herein, although not shown, the frictional load is suddenly increased by restitution of the wiping blade 7b when the wiping blade 7b is removed from the print head 3.

FIG. 3 shows a current (torque) change of the motor during a wiping operation, in which the portion marked as B represents a load state when the wiping blade 7b initially contacts the print head 3 (that is, the state shown in FIG. 2B). The portion marked as C represents a load state while the wiping blade 7b wipes the print head 3 (that is, the state shown in FIG. 2C). The portion marked as D represents a stall state in that the motor is no longer driven after the wiping operation for a predetermined area is finished. The stall state means a state where the wiping blade 7b is out of the wiping area determined by initially setting the number of rotations of the motor, which then oppositely rotates the wiping blade back into the wiping area (that is, the area where the wiping blade 7b is in contact with the print head 3). When it is sensed as the stall state, the motor is driven in an opposite direction to perform the wiping operation.

The reason for setting the driving condition of the motor as described above is to define the movement area of the wiping blade 7b by setting the number of rotations of the motor, instead of using any additional sensors.

As shown in FIG. 3, when the wiping blade 7b is in contact with the print head 3, the load state is very large and thus there is a problem in misunderstanding it as the state D in which the wiping blade is out of the wiping area.

FIG. 4 shows a structure disclosed in Japanese Laid-Open Patent Publication (Hei 11-286116) as another example of an inkjet printer to which the conventional wiping apparatus is applied.

The life of the wiping apparatus is extended by reducing the friction of a wiping blade 32, When a cartridge 20 moves in the direction indicated by arrow C, an edge portion 32a of the wiping blade 32 wipes a bottom surface 20a of a print head. When the cartridge 20 moves in the direction indicated by arrow B, an edge portion 32b of the wiping blade 32 wipes the bottom surface 20a of the print head.

The structure of the aforementioned Japanese Laid-Open Patent Publication can reduce the frictional load, compared to the structure of FIG. 1. However, when the wiping blade 32 initially contacts the print head 20, the frictional load suddenly occurs due to the same structure where the wiping blade 32 is disposed at a right angle to the movement direction.

Accordingly, a need exists for a wiping apparatus for a print head in an inkjet printer to substantially prevent an increase in frictional load during a wiping operation.

### SUMMARY OF THE INVENTION

Accordingly, it is an object of the present invention to provide a wiping apparatus for a print head in an inkjet printer that is capable of reducing a frictional force between a wiping blade and a print head by disposing the wiping blade at an angle.

Another object of the present invention is to provide a wiping method for a print head in an inkjet printer that reduces a frictional load that occurs when a wiping blade and a print head are in contact with each other during a wiping operation.

A wiping apparatus for a print head in an inkjet printer includes a blade support and a wiping blade disposed on an upper surface of the blade support such that the contact point of the wiping blade with the print head is not on the same line, that is, the line formed by the contact point between the wiping blade and the print head is not perpendicular to a wiping direction.

Preferably, the wiping blade may be disposed on the upper surface of the blade support to bend at a predetermined angle in a wiping direction.

The wiping blade may be disposed to be substantially perpendicular to the upper surface of the blade support.

The blade support may be an ink absorption body.

The print head may be wiped when the blade support moves relative to the print head.

The print head may be wiped when the print head moves relative to the blade support.

The print head may be wiped when the print head and the blade support move at the same time relative to each other.

In accordance with another aspect of the present invention, a wiping method for a print head in an inkjet printer includes the steps of sequentially contacting a wiping blade with a bottom surface of the print head along its longitudinal direction and sequentially removing the wiping blade from the print head along its longitudinal direction.

Preferably, the wiping blade may be disposed to bend at a predetermined angle in the wiping movement direction.

Preferably, the wiping blade may be disposed to bend at a predetermined angle based on an axis being at a right angle to the wiping movement axis.

The wiping blade may disposed to be substantially perpendicular to the upper surface of the blade support.

The print head may be wiped when the blade support moves relative to the print head.

The print head may be wiped when the print head moves relative to the blade support.

The print head may be wiped when the print head and the blade support move at the same time relative to each other.

According to the exemplary embodiments of the present invention, disposing the wiping blade to bend along the movement axis substantially prevents a frictional load from suddenly increasing when the wiping blade initially contacts the print head and substantially prevents the frictional load from suddenly increasing by the restitution of the wiping blade when the wiping blade is removed from the print head.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain exemplary embodiments of the present invention with reference to the accompanying drawings, in which:

FIG. 1 shows a structure of a conventional wiping apparatus for a print head in an inkjet printer;

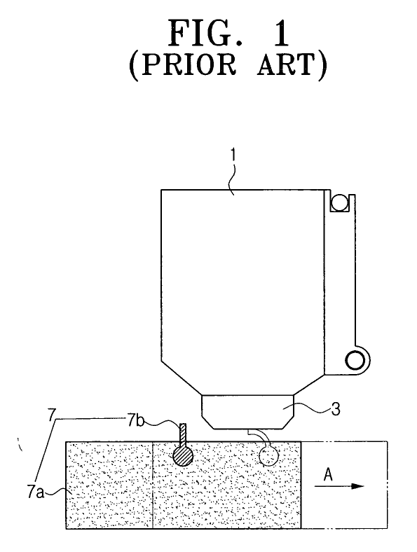

FIGS. 2A to 2D show states of a wiping blade of the conventional wiping apparatus of FIG. 1 in contact with a print head in a wiping movement direction;

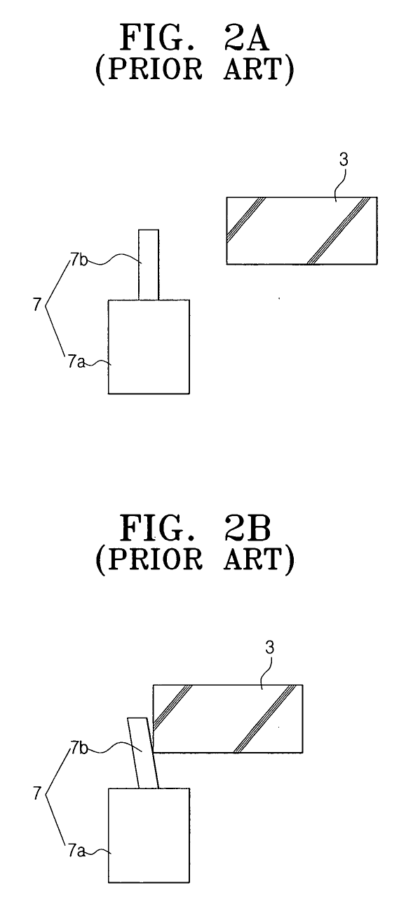

FIG. 3 is a graph showing load conditions for a motor when the wiping blade is in contact with the print head;

FIG. 4 shows a structure disclosed in Japanese Laid-Open Patent Publication (Hei 11-286116) as another example of an inkjet printer having a conventional wiping apparatus;

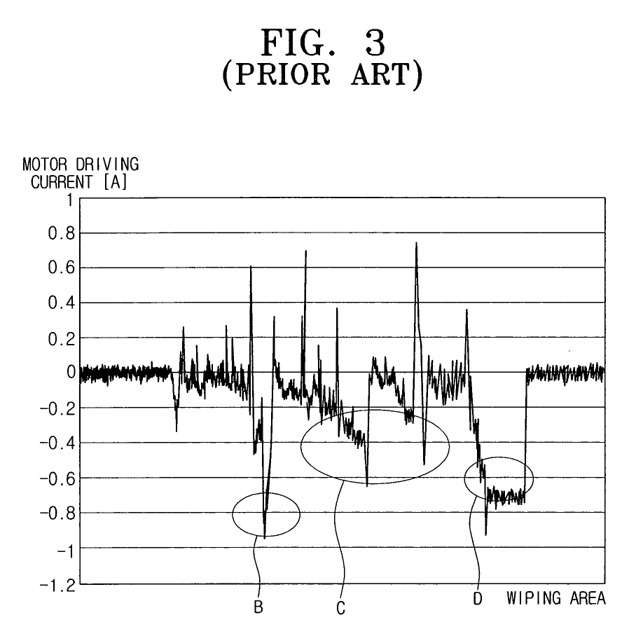

FIG. 5 is a schematic view of an inkjet printer having a wiping apparatus for a print head according to an exemplary embodiment of the present invention;

FIG. 6 is a side elevational view taken along arrow V of FIG. 5;

FIG. 7 is an enlarged perspective view of the wiping apparatus according to an exemplary embodiment of the present invention;

FIG. 8 is a top plan view taken along arrow VII of FIG. 7;

FIGS. 9A to 9C illustrate the wiping apparatus during a wiping operation according to an exemplary embodiment of the present invention in operation; and

FIG. 10 is a graph of load conditions on a motor during a wiping operation with a wiping apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The wiping apparatus according to an exemplary embodiment of the present invention is described in more detail with reference to the included drawings.

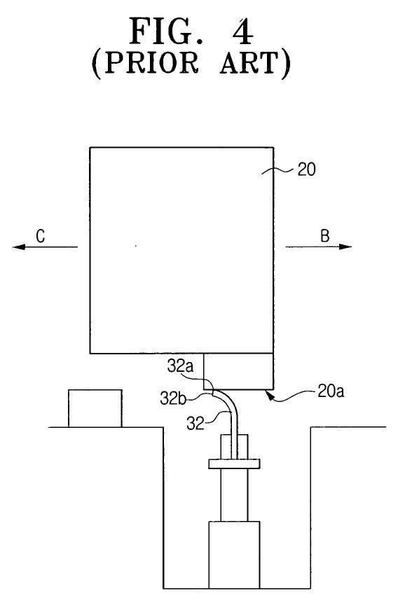

FIG. 5 is a schematic view of an inkjet printer having a wiping apparatus according to an exemplary embodiment of the present invention.

Referring to FIG. 5, an inkjet printer 100 includes a recording medium supply unit 110 for supplying a recording medium 101, and a transfer unit 130 for transferring the recording medium 101 received from the recording medium supply unit 110. An image formation unit 150 prints an image on the recording medium 101 transferred by the transfer unit 130. A recording medium eject unit 170 ejects outwardly the recording medium 101 printed by the image formation unit 150. A driving unit 190 moves the image formation unit 150 back and forth.

The recording medium supply unit 110 includes an automatic feeder 111 for receiving the recording medium 101 and a pickup roller (not shown) for transferring the recording medium 101 received in the automatic feeder 111 to the transfer unit 130.

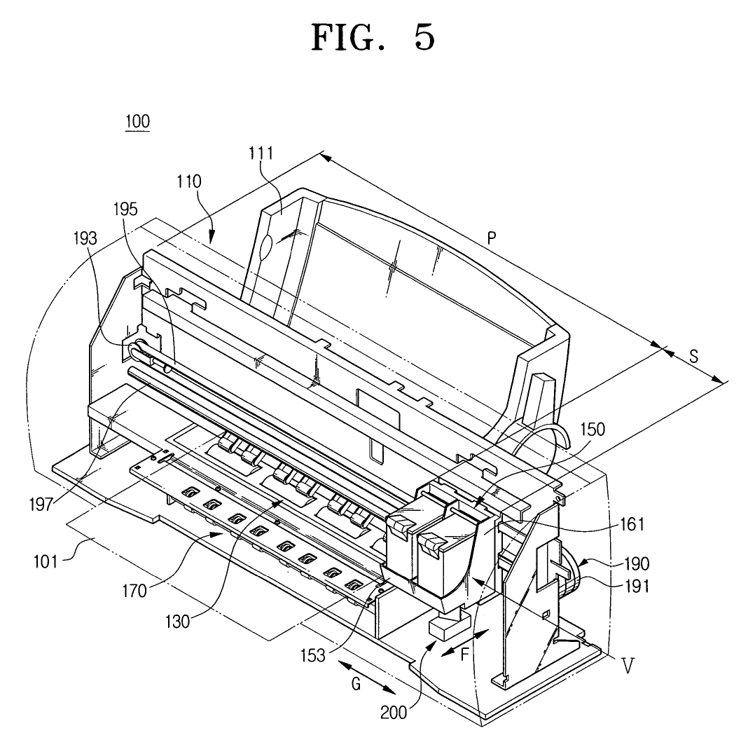

The image formation unit 150 forms an image on the recording medium 101 transferred through the recording medium supply unit 110. A cartridge 153 has a print head 151 attached thereto (referring to FIG. 6) that sprays ink droplets. The cartridge is disposed in a carriage 161 and is moved according to the right and left movement of the carriage 161.

The driving unit 190 includes a motor 191 and a driving pulley (not shown) connected with the motor 191. An idle pulley 193 is disposed on the side opposite to the driving pulley. A timing belt 195 is disposed on an outer circumferential surface of the driving pulley and the idle pulley 193.

In the inkjet printer described above, the print head 151 mounted on the carriage 161 is moved from side to side, and this back and forth movement area is divided into a printing area P for performing a printing operation by the print head 151 and a service area S for cleaning the print head 151 and performing a nozzle closing function to substantially prevent ink from being vaporized.

Accordingly, the service area S is provided with a maintenance device. FIG. 5 shows a wiping apparatus 200.

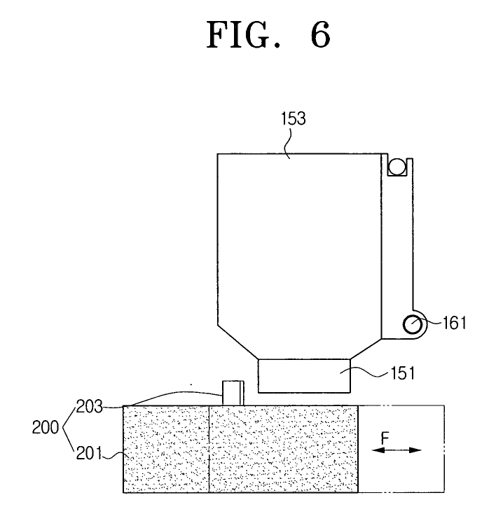

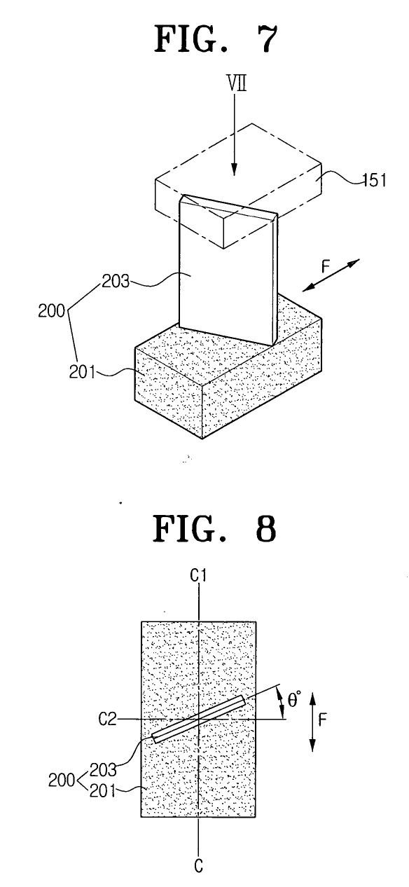

FIG. 6 is a side elevational view taken along line V of FIG. 5. FIG. 7 is an enlarged perspective view of the wiping apparatus according to an exemplary embodiment of the present invention. FIG. 8 is a top plan view taken along line VII of FIG. 7.

With reference to FIGS. 6 to 8, the wiping apparatus 200 includes a wiping support 201 disposed at a predetermined distance from a bottom surface of the print head 151 and a wiping blade 203 disposed on an upper surface of the blade support 201. Preferably, the wiping blade 203 is not perpendicular to an edge of the blade support 201, as shown in FIG. 8. The blade support 201 forms an absorption body for absorbing ink such that the ink wiped by the wiping blade 203 may be absorbed. The blade support 201 moves in the direction indicated by arrow F to wipe the bottom surface of the print head 151. The wiping blade 203 is shown as moving straight back and forth and wiping the print head 151 in the direction at approximately a right angle to the straight back and forth movement direction of the cartridge 153. The wiping operation may move the wiping blade 203 as described above, move the print head 151 in the state where the wiping blade 203 is stopped, or move both the print head 151 and the wiping blade 203 at the same time.

The wiping blade 203 is disposed to bend at a predetermined angle on the upper surface of the blade support 201 to reduce a frictional load with the print head 151. Preferably, the wiping blade 203 may be disposed to bend at the predetermined angle (θ°) along a wiping movement axis C1, that is, around an axis C2 being at approximately a right angle to the wiping movement axis C1. The direction that the wiping blade 203 is bent may be different according to the wiping movement direction.

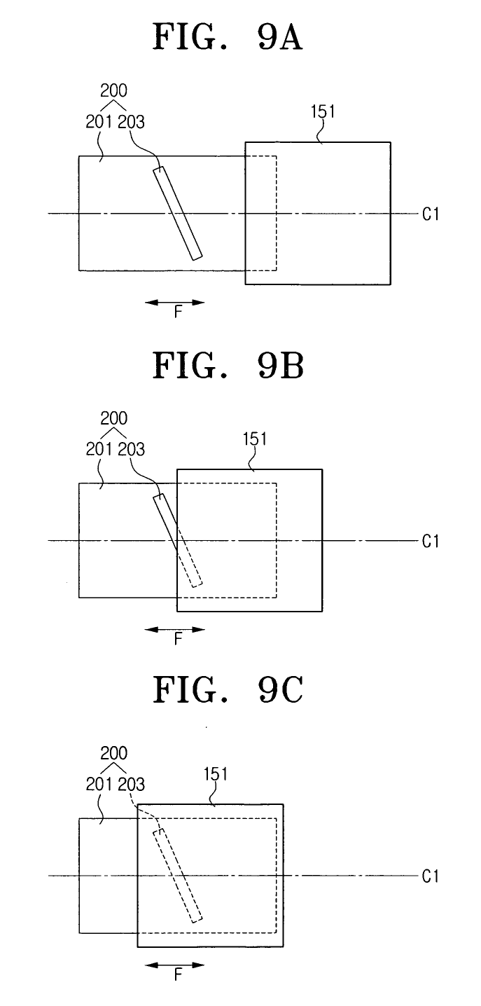

FIGS. 9A to 9C show the wiping apparatus according to an exemplary embodiment of the present invention in operation.

As shown in FIGS. 9A to 9C, the wiping blade 203 is disposed to bend along the movement axis C1 and to be sequentially in contact with the print head 151. Consequently, this substantially prevents the frictional load from suddenly increasing when the wiping blade 203 is in contact with the print head 151.

Although not shown in the drawings, reduction of the influence of the restitution as generated at the point that the wiping blade 203 is removed from the print head 151. That is, as the wiping blade 203 is sequentially removed from the print head 151, the frictional resistance by the restitution of the wiping blade 203 does not concurrently but sequentially generate as at the contact time.

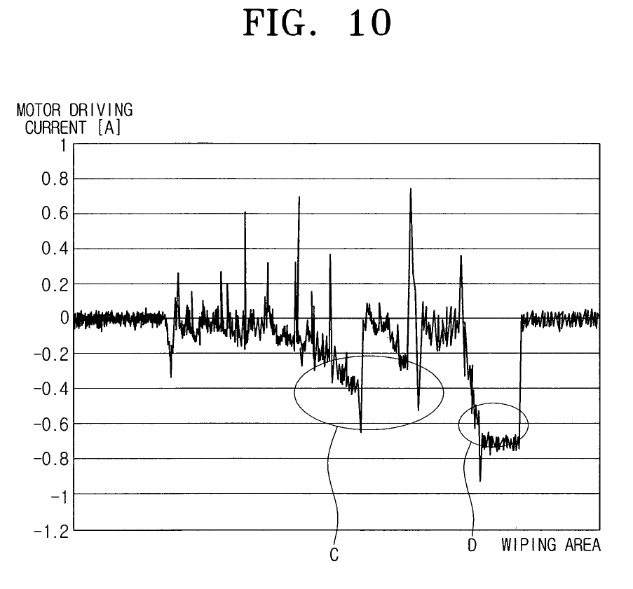

FIG. 10 shows a load state of the motor in the movement area of the wiping apparatus according to an exemplary embodiment of the present invention.

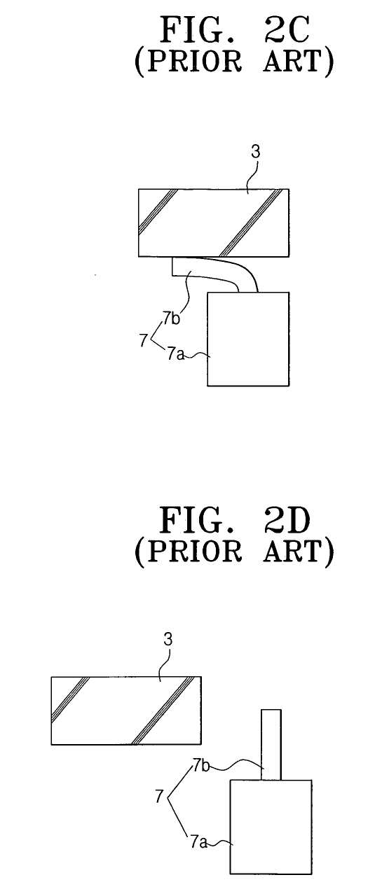

With reference to FIG. 10, there is found no portion (like the portion marked as B in FIG. 3) in which the frictional load is suddenly increased in the movement area such that it is sensed as a stall state, compared to FIG. 3.

Consequently, there is an advantage in processing in a reverse direction after wiping a certain area or misunderstanding the time point to stop the wiping operation.

The foregoing embodiments and advantages are merely exemplary and are not to be construed as limiting the present invention. The present teaching may be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A wiping apparatus for a print head in an inkjet printer, comprising:
a blade support; and
a wiping blade disposed on an upper surface of the blade support such that a line formed by a contact point of the wiping blade with the print head is not perpendicular to a wiping direction.

2. The apparatus according to claim 1, wherein
the wiping blade bends at a predetermined angle in a wiping direction on the upper surface of the blade support upon contacting the print head.

3. The apparatus according to claim 2, wherein
the wiping blade is substantially perpendicular to the upper surface of the blade support.

4. The apparatus according to claim 1, wherein
the blade support is an ink absorption body.

5. The apparatus according to claim 1, wherein
the print head is wiped when the blade support moves relative to the print head.

6. The apparatus according to claim 1, wherein
the print head is wiped when the print head moves relative to the blade support.

7. The apparatus according to claim 1, wherein
the print head is wiped when the print head and the blade support move at the same time relative to each other.

8. The apparatus according to claim 1, wherein
the wiping blade is not perpendicular to an edge of the blade support.

9. The apparatus according to claim 5, wherein
the blade support moves substantially perpendicularly to the direction of travel of the print head.

10. The apparatus according to claim 6, wherein
the print head moves substantially perpendicularly to the blade support.

11. The apparatus according to claim 7, wherein
the print head and the blade support move substantially perpendicularly to each other.

12. A wiping method for a print head in an inkjet printer, comprising the steps of
sequentially contacting a wiping blade with a bottom surface of the print head in a longitudinal direction; and
sequentially removing the wiping blade from the print head in the longitudinal direction.

13. The method according to claim 12, wherein
the wiping blade bends at a predetermined angle in a wiping movement direction.

14. The method according to claim 12, wherein
the wiping blade is disposed to be substantially perpendicular to the upper surface of the blade support.

15. The method according to claim 12, further comprising
moving the blade support relative to the print head to wipe the print head.

16. The method according to claim 15, further comprising
moving the blade support substantially perpendicularly to print head.

17. The method according to claim 12, further comprising
moving the print head relative to the blade support to wipe the print head.

18. The method according to claim 17, further comprising
moving the print head substantially perpendicularly to the blade support.

19. The method according to claim 12, further comprising
moving the print head and the blade support at the same time relative to each other to wipe the print head.

20. The method according to claim 19, further comprising
moving the print head and the blade support substantially perpendicularly to each other.
